(19) United States
(12) Patent Application Publication
(10) Pub. No.: US 2010/0327223 A1
(43) Pub. Date: Dec. 30, 2010

(54) Lithium Iron Phosphate Cathode Materials With Enhanced Energy Density And Power Performance

(75) Inventors: Karim ZAGHIB, Quebec (CA); Patrick Charest, Quebec (CA); Abdelbast Guerfi, Quebec (CA); Guoxian Liang, Quebec (CA)

Correspondence Address: CROWELL & MORING LLP;INTELLECTUAL PROPERTY GROUP, P.O. BOX 14300, WASHINGTON, DC, 20044-4300, US

(73) Assignee: Phostech Lithium Inc., St-Bruno-de-Montarville (CA)

(21) Appl. No.: 12/827,565

(22) Filed: Jun. 30, 2010

Related U.S. Application Data
(63) Continuation of application No. 12/000,625, filed on Dec. 14, 2007.

(51) Int. Cl. H01M 4/90; B05D 5/00

(52) U.S. Cl. 252/182.1; 427/122

(57) ABSTRACT

The invention is related to a cathode material comprising particles having a lithium metal phosphate core and a pyrolytic carbon deposit, said particles having a synthetic multimodal particle size distribution comprising at least one fraction of micron size particles and one fraction of submicron size particles, said lithium metal phosphate having formula LiMPO₄ wherein M is at least Fe or Mn.

Said material is prepared by method comprising the steps of providing starting micron sized particles and starting submicron sized particles of at least one lithium metal phosphate or of precursors of a lithium metal phosphate; mixing by mechanical means said starting particles; making a pyrolytic carbon deposit on the lithium metal phosphate starting particles before or after the mixing step, and on their metal precursor before or after mixing the particles; optionally adding carbon black, graphite powder or fibers to the said lithium metal phosphate particles before the mechanical mixing.

### CROSS-REFERENCE TO RELATED APPLICATIONS

This application is a continuation of U.S. application Ser. No. 12/000,625, filed Dec. 14, 2007, which is incorporated by reference in its entirety herein.

### FIELD OF ART

The present invention relates to mixtures of lithium iron phosphate materials with olivine structure and thin layer of carbon deposits on particle surface for use in a lithium ion battery. In particular, the invention relates to the preparation and use of mixtures of carbon coated lithium iron phosphate materials with various particle size distributions and morphology to achieve enhanced energy density and power performance.

### BACKGROUND OF THE INVENTION

Lithium ion rechargeable batteries have progressively replaced existing Ni—Cd and Ni-MH batteries since their introduction into the market in early 90's because of their superior energy storage capacity. However, only small size batteries have been commercialized with success in most portable electronic applications using LiCoO2 cathode materials, owing to the cost and intrinsic instability under abusive conditions, especially in their fully charged state.

Lithium iron phosphate with olivine structure has been envisaged as an excellent candidate for cathode materials in large size lithium ion batteries due to its intrinsic safety, low material cost and environment benign feature. The covalently bounded oxygen atom in the phosphate polyanion eliminates the cathode instability against O2 release observed in fully charged layered oxides (U.S. Pat. No. 5,910,382).

Drawbacks associated with the covalently bonded polyanions in LiFePO4 cathode materials are the low electronic conductivity and limited Li⁺ diffusivity in the solid, which consequently lead to slow electrode kinetics. The slow kinetics and the relatively low specific density of the lithium iron phosphate active material make it very challenging to achieve compact, high energy density and high power batteries.

The low electronic conductivity can be significantly improved by surface carbon deposition using organic pyrolysis as disclosed in the laid open patent U.S. Pat. No. 6,855,273, while the slow lithium ion diffusion can be mitigated via using nano or submicron sized particles by reducing the diffusion length as taught in the U.S. Pat. No. 5,910,382 patent. The performance of lithium iron phosphate is significantly improved by using fine particles with thin carbon deposits on particle surface. However C deposited on the surface of the polyanion phosphates to induce conductivity is not an active material and represents dead weight than must be minimized relatively to the active material, especially when submicron particles (primary nano or secondary nanoscaled) are to be C deposited. Composite electrode coating and optimization is made difficult with large surface submicron particles and this is accentuated by the carbon deposit itself that is usually associated with large effective surface (both characterized by BET measurement).

With small particle size it becomes extremely challenging to make high density electrode with the use of minimum amount of conductive additive and polymer binder while having optimized pore size and porosity to achieve fast transport of lithium ions from the electrolyte and from the opposite electrode and to provides lithium salt reservoirs in the composite electrode. These are essential to support sustain current and solid state chemical diffusion of ions and electrons from the surface into the interior of active materials for high rate charge/discharge of metal phosphate cathode materials.

It is known that the electrode porosity, the viscosity of the electrolyte and the separator and composite electrode film thickness have a great impact on the rate performance of batteries using sub-micron-sized lithium metal phosphate cathode materials with surface a carbon deposits. Increasing the amount of carbon in the electrode, decreasing the packing density or using an electrolyte with lower viscosity and higher ionic conductivity improves the rate performance. A larger electrode resistance and a slower Li-ion transport through the electrolyte causes inferior performance for a thick electrode. Thin electrode in turn affects the energy density of a battery, because the percentage of inactive materials increases with decreasing film thickness.

When the active material particle size is decreased to submicron or nanometer range, it becomes much more difficult to control and achieve homogeneous porosity by mechanically pressing the electrode. The pore size in the cathode decreases with decreasing particle size. The pore channel becomes more tortuous. The requirement for additional conductive carbon and polymer binder also increases. To tailor the porosity and pore size/size distribution in the electrode becomes essential to achieve fast transport of lithium ions through the electrolyte to the surface of active material particles. Furthermore to tailor and limit the C deposit on the submicron particles is also essential: C wt % ratio, thickness, degree of graphitization (to increase conductivity) . . . etc.

Clearly, there is a need to further improve the particle size distribution and conductivity of lithium iron phosphate materials for high energy and high power application. In the prior art, various processes including solid state reactive sintering, melt casting and hydrothermal reaction, have been used to make lithium iron phosphate or carbon-coated lithium metal phosphate materials. The particle size and particle morphology achievable depends on the processing route and the process parameters. Usually the possibility of tailoring particle size and size distribution is limited for each different processing route.

After systematic research and developments, the inventors have identified methods to make specific mixtures of carbon deposited lithium iron phosphate materials of different particle sizes, morphology, or C ratio to obtain electrodes with better energy packing and high rate power. More specifically it has been shown that certain mixtures present improved energy density and power performance.

### SUMMARY OF THE INVENTION

In the present invention, the inventors found that the packing density of lithium metal phosphate active materials and their power performance at very high discharge rate can be improved by making active materials mixtures of fine (submicron size) and coarse (micron size) particles of various particle sizes and distributions.

The fine and coarse particles are obtained by two different synthesis processes since every process is usually characterized (or adjusted) to specific particles sizes and distribution, and characteristic morphology. However, a same synthesis process using different parameters to get different particle sizes is to be considered as two different synthesis in the present invention.

In “micron particle” or “submicron particle size”, “particle” means an elementary particle or a secondary particle. An elementary particle comprises a single crystallite. A secondary particle is a strong agglomerate containing several crystallites and behaves as a single particle during the mechanical mixing step.

“Particle morphology” means the particle shape, which can be spherical, partially spherical, irregular, acicular or a platelet shape. Particle size means the average dimension in each direction, being understood that further optimization can be obtained by the specialist by proper selection of each particle morphology. The multi-modal particle size distribution of a cathode material can improve the homogeneity of porosity and pore size and therefore improve the active material utilization for very high power application. According to the requirements of energy density and power performance at various discharge rates, the packing density and porosity can be tailored by changing the size ratio, the broadness of size distribution and the volume fraction of the fine particles and coarse particles.

In one aspect, the present invention provides a cathode material comprising particles having a lithium metal phosphate core and a thin pyrolytic carbon deposit, wherein said particles have a multimodal particle size distribution, and said lithium metal phosphate has formula LiMPO₄ wherein M is at least Fe or Mn. A thin carbon deposit has preferably a thickness of 1-20 nm, more preferably 1-10 nm.

In a preferred embodiment, the size distribution is bimodal.

Lithium metal phosphate means a compound of the general formula LiMPO₄ in which M represents FeII or MnII optionally partly replaced with not more than 50 atomic % of at least one metal selected in the group consisting of Mn, Fe, Ni et Co, and optionally replaced with not more than 10 atomic % of at least one aliovalent or isovalent metal different from Mn, Ni or Co. The aliovalent or isovalent metal is preferably selected from Mg, Mo, Nb, Ti, Al, Ta, Ge, La, Y, Yb, Sm, Ce, Hf, Cr, Zr, Bi, Zn, Ca et W. LiFePO₄ and LiMnPO₄ are particularly preferred.

In a further aspect, the present invention provides a method for making the said cathode material, starting from different LiMPO₄ materials obtained via different synthesis way and with various particle sizes and morphology and/or LiMPO₄ precursors, and optionally of C.

### BRIEF DESCRIPTION OF THE DRAWINGS

FIG. 1 represents SEM images of three C—LiFePO₄ materials obtained in Example 1 from various iron phosphate precursors
a) using 100% ALEP submicron size particle precursor;
b) using 100% Budenheim micron size particle precursor;
c) using 30% ALEP submicron size particle precursor and 70% Budenheim micron size particles particle precursor.

FIG. 2 shows the Ragone plot of the three samples of example 1.
LFP070314: obtained from 100% ALEP submicron size particle precursor;
▪ JM07013B024: obtained from 100% Budenheim micron size particle precursor
+ LFP070530: obtained from 30% ALEP submicron size particle precursor and 70% Budenheim micron size particles particle precursor.

FIG. 3 represents SEM images of the molten LiFePO₄ after jet milling and carbon coating showing different particle size combination.

FIG. 4 represents a SEM image of micron sized particles with thin layer of carbon deposition on particle surface.

FIG. 5 illustrates an optimised carbon coating layer of about 2-5 nm on fine submicronic particles.

FIG. 6 illustrates the general trend on packing density for mixtures made with components of different origin or treatment.

FIG. 7 illustrates the beneficial effect of a thin carbon deposit on submicron nanometer size particles on energy packing.

FIG. 8 shows the rate performance of different cathode compositions of Example 4.

FIG. 9 is a schematic drawing illustrating the structure difference of a monomodal material and a bimodal material. HT designated particles obtained via hydrothermal reaction. SS designates particles obtained via solid state sintering.

FIG. 10 illustrate how the Coarse particles (P1-SS) act as buffer for fine particles (P2-HH) when high rate is required.

### DETAILED DESCRIPTION OF THE INVENTION

In one embodiment, the core of all the particles is made of a lithium metal phosphate having the same chemical formula LiMPO₄. In another embodiment, the lithium metal phosphate of particles having one size distribution is different from the lithium metal phosphate of particles having a different size distribution.

In a preferred cathode material of the invention, the micron sized particles have a D50 in the range of 1-5 μm and a D97 of less that 10 μm, and the submicron sized particles have a D50 of 0.1-0.5 μm and a D97 of less than 10 μm, preferably less than 4 μm.

The median size ratio of the submicron to micron sized particles is preferably in the range of 0.02-0.5, more preferably in the range of 0.08-0.15.

The micron size particles and submicron size particles are made of primary particles each consisting of a single phosphate crystallite, or of secondary particles each consisting of a plurality of phosphate crystallites and behaving as a single crystallite.

A bimodal cathode material of the invention the particle size distribution comprises micron size particles and submicron size particles.

In cathode material of the invention wherein the particle size distribution is trimodal, said material comprises 3 fractions of particles, wherein at least one fraction consists of submicron size particles, and at least one fraction consists of micron size particles.

The volume fraction of the submicron particles is preferably in the range of 20-50%, preferably in the range of 25-35%.

The pyrolytic carbon deposit on submicron particles represents preferably a ratio of 0.5 to 10% wt in the mixture and more preferably between 0.5 to 2.5% wt. Said pyrolytic carbon deposit in the submicron sized particles is preferably a carbon layer of partially graphitized carbon attached to the particle surface having a thickness of 1 to 15 nm.

A cathode material of the invention may further comprise additional carbon in the form of C black, graphite, or fibers, between the particles which are agglomerated or not agglomerated.

The cathode material of the present invention may be prepared by a method comprising the steps of:
providing starting micron sized particles of at least one lithium metal phosphate or of precursors of a lithium metal phosphate;
providing starting submicron sized particles of at least one lithium metal phosphate or of precursors of a lithium metal phosphate;
mixing by mechanical means said starting micron sized particles and said starting submicron size particles;
making a pyrolytic carbon deposit on the lithium metal phosphate starting particles before or after the mixing step, and on their metal precursor before or after mixing the particles;
optionally adding carbon black, graphite powder or fibers to the said lithium metal phosphate particles before the mechanical mixing.

In one embodiment, the median size ratio of the starting submicron size particles to the starting micron sized particles is in the range of 0.08-0.15 and the volume fraction of the starting submicron size particles in the range of 20-50%, and/or the starting submicron sized particles have a D50 of 0.2-0.3 μm and a D100 of less than 4 μm.

In another embodiment, the starting micron sized particles have a D50 in the range of 2-3 μm and a D100 of less that 10 μm.

In one embodiment, the starting micron size particles and the starting submicron size particles may all be LiMPO₄ particles, wherein the synthesis route of the starting micron size particles is different from the synthesis route of the starting submicron size particles, or not.

In another embodiment, the starting micron size particles and the starting submicron size particles are LiMPO₄ precursors particles.

In a further embodiment, the starting micron size particles are LiMPO₄ particles and the starting submicron size particles are LiMPO₄ precursor particles, or the starting micron size particles are LiMPO₄ precursor particles and the starting submicron size particles are LiMPO₄ particles, wherein the lithium metal phosphate or the precursors of a lithium metal phosphate of the starting micron sized particles are different from the lithium metal phosphate or the precursors of a lithium metal phosphate of the starting submicron sized particles.

In the method of the present invention, the mixing step by mechanical means may be a dry mixing or a mixing in a liquid medium. They may be selected from high shear mixing, wet milling, cogrinding, magnetically assisted impaction mixing, hydrydization system, mechanofusion, and micro superfine mill.

Non carbonated starting particles (LiMPO₄ or precursors thereof) may be prepared by various synthesis method. The synthesis method may be:
a precipitation—hydrothermal synthesis reaction, optionally followed by grinding or milling to micron size or submicron size;
solid state sintering, optionally followed by grinding or milling to micron size or submicron size;
a molten process, optionally followed by grinding or milling to micron size or submicron size;
a sol-gel or by spray pyrolysis methods of synthesis; or
jet milling of larger particles.

Starting particles having a carbon deposit (carbonated LiMPO₄ or carbonated precursors thereof) may be prepared by various methods, for example:
precipitation-hydrothermal synthesis reaction are mixed with a carbon precursor and pyrolyzed;
solid state sintering is performed in the presence of a carbon precursor;
a molten process performed in the presence of a carbon precursor.

In the method of the present invention, the thin carbon deposit can be provided by using starting micron size particles and starting submicron size particles which are LiMPO₄ particles having a carbon deposit.

When the starting micron size particles and/or the starting submicron size particles are LiMPO₄ precursor particles, the mixture subjected to mixing comprises a carbon precursor, and pyrolysis is performed after mixing, to provide a carbon deposit on the cathode material.

When the starting micron size particles and/or the starting submicron size particles are LiMPO₄ particles having no carbon deposit, the mixture subjected to mixing comprises a carbon precursor, and pyrolysis is performed after mixing.

Study of the impact of particle size on the performance of lithium iron phosphate materials is necessary to be able to synthesize said materials in a controlled manner. First of all, the inventors have explored various solid state reaction processes using various iron precursors under reducing or inert atmospheres to synthesize lithium iron phosphate and found out that the particle size of the final C/LiFePO₄ product can be well controlled and determined by using some typical iron precursors. Representative description of the different synthesis routes for the products used in the present invention can be found in WO-0227823, U.S. Pat. No. 7,285,260, WO-05062404A1 and WO-2005/051840A1. For instance, at well controlled low reaction temperatures with polymeric additive used as reducing agent and a carbon conductor source, the final particle size of lithium iron phosphate can be controlled by regulating the particle size of FePO₄.2H₂O used as the precursor.

Different synthesis process are known that lead directly to micron size particles and even to submicron size particles when properly optimized, especially when carbon powder carbon deposit or coating are used during the heat treatment to avoid sintering of LiMPO₄ or of its precursors. For example, solid state sintering, wet precipitation process of LiMPO₄ or of its precursors or precipitation/hydrothermal can easily lead to micron size particles and in some cases to submicron particles down to 20-30 nm. Techniques like spray pyrolysis or sol gel are also available to obtain nanoscales crystals. At this nanometer scale, the particles are frequently present as agglomerates of finer crystals.

Other synthesis such as molten or some solid state sintering need top-down grinding/milling techniques such as dry or wet milling or other mechanical means such as crushers in combination with jet mill. In this case, micron size particles are usually obtained. However wet nanogrinding is also feasible to make submicron primary or secondary particles made of 20-40 nm crystals.

When particles to be mixed are secondary particles (made of a plurality of crystals) or agglomerates made during the heat treatment step for example, jet-milling can currently be used to control their size at the micron size level, alternatively to control primary or secondary submicron particle size. A preferred but not limitative way is to use high energy wet milling techniques.

FePO₄.2H₂O is usually made through wet precipitation process and the final particle size of the product can be regulated by controlling the precipitation conditions. Submicron sized particles and micron sized particles including particle aggregates made from elementary particles can be obtained. The micron sized particles can be jet milled to further regulate the particle size distribution. In practice, irregular particles in the range of 1-10 microns can be achieved. A small fraction of fine particle in the submicron range can also be produced.

FePO₄.2H₂O made by a wet precipitation process is available commercially, for example from Buddenheim, Germany. Iron phosphate received from Budenheim jet milled by using dry air provides particles having a particle size with D50 of 2-3 microns and designates hereinafter by “Budenheim coarse particles”.

Experiments have been made to synthesize lithium iron phosphate starting from iron phosphate precursors with different particle size. Submicron size FePO₄ particles prepared by a precipitation process, starting from iron chloride and phosphoric acid, were obtained from Süd-Chemie. They are designated hereinafter by “ALEP particles”. Submicron sized LiFePO₄ particles can be made by a controlled precipitation techniques. For example, precipitated particles made starting from iron chloride are platelets with plate size of 0.2-0.3 microns and plate thickness of 0.1 micron. Submicronic LiFePO₄ particles obtained by a precipitation process are designated hereinafter by “Süd-Chemie LiFePO₄ fine particles”

As used hereinafter, “coarse particles” means “micron size particles” and “fine particles” means “submicron size particles”

Experiments have been made to synthesize lithium iron phosphate starting from iron phosphate precursors with different particle size distributions. The ALEP fine particles have been used as fine particles, and the Budenheim coarse particles have been used as coarse particles.

In the present invention multimodal mixtures of micron and sub-micron particles are made, preferably from different synthesis routes, by mixing different iron precursors, or mixing different ‘already synthesized’ LiMPO₄ materials or both.

The inventors have found easier and surprisingly more efficient to make synthetic mixture of particle from different synthesis process to optimize cathode active material density and performance.

Because electrically insulating lithium metal phosphate needs a conductive carbon deposit and because carbon is a dead weight in batteries, the amount of carbon deposit on the LiMPO₄ particles is kept under 5% and preferentially under 2.5%. Furthermore, a preferred form of the C is as a very thin deposit of graphene layers or nodules on the surface of the particles, especially the sub-micron particles. This is important since graphitized or partially graphitized C-layer is more conductive and develops less effective surface than amorphous carbon or carbon black. In a preferred embodiment, especially for sub-micron particles, the C deposit has a thickness in the 1-10 nanometers range and adheres on the surface of the submicron particles, and “C layer thickness”/“phosphate particle thickness” ratio is of less than 10%. It is important to note that even if a C deposit is a continuous coating on the surface of the LiMPO₄ particles, irregular C deposit on only part of the surface or inside the particles is included in this invention as long as there is an adherent C deposit at least on the surface and in quantity sufficient to insure electronic exchanges between the particle reactive material with the conductive carbon of the composite electrode and the current collector.

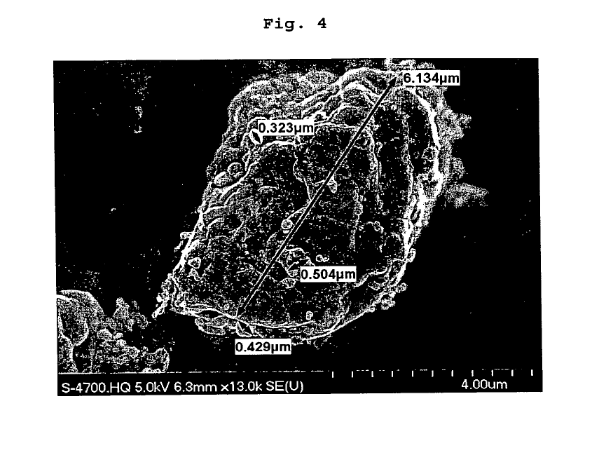

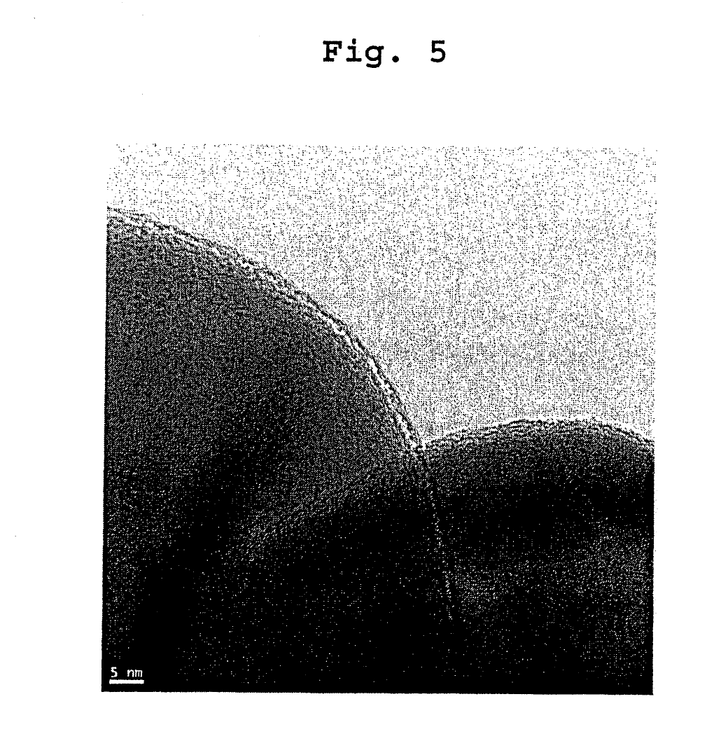

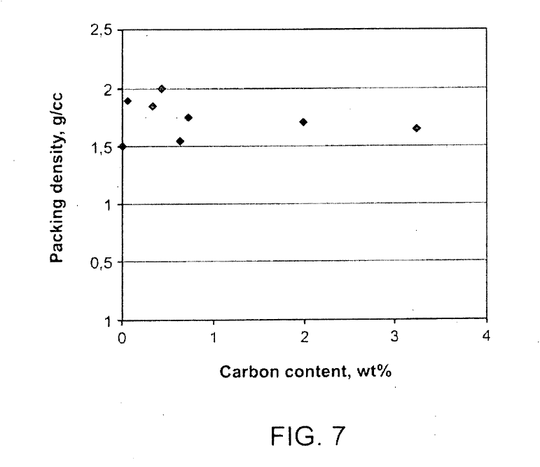

A typical carbon deposit on submicron LiMPO₄ fine particles as used in Example 4 to optimize sub-micron particles used for a bimodal material, is illustrated on FIG. 5. The beneficial effect of a thin carbon deposit on submicron nanometer size particles on energy packing is shown in FIG. 7, higher energy packing being obtained at low carbon content. Adhesion of the pyrolytic carbon deposit on the lithium metal phosphate particles is essential to preserve conductivity during the mixing process, and the composite cathode compounding and coating. Carbon coating on the particles can be made on the M metal precursor or on the final LiMPO₄ product individually before particle mixing or after particle mixing.

### Mixing Two Lithium Metal Phosphate Precursors Before C-Coating.

In a first embodiment, a LiFePO₄ bimodal material was prepared from FePO₄.2H₂O particles, starting from Budenheim coarse particles and from ALEP particles. Said particles were mixed with lithium carbonate and a conductive-C polymeric organic precursor, acting also as the source of reductive gases, introduced as an IPA solution. The solid precursors and the solution were intimately mixed by ball milling using ceramic beads. The slurry obtained after mixing was dried and then sintered progressively to a temperature of 710° C. in a rotary kiln under the protection of N₂ flow.

As shown in example 1, when 30 wt. % of submicron iron phosphate precursor particles (ALEP) were mixed with 70 wt. % of Budenheim micron sized iron phosphate precursor particles with an amount of carbon representing 1.42% vs LiFePO₄, the final C—LiFePO₄ bimodal material gives higher packing density than the individual components made of 100% ALEP fine particles or of 100% of Budenheim coarse particles precursors as shown in Table 1.

TABLE 1

| | Packing density |
|---|---|
| Material | (g/cc) |
| Starting from 100% Budenheim coarse particles | 2.08 |
| Starting from 100% ALEP fine particles | 2.01 |
| Starting from 30% ALEP fine particles and 70% | 2.21 |
| Budenheim coarse particles | |

SEM observation shows that the final C—LiFePO₄ obtained from the mixed precursors gives a mixture of fine and coarse particles as in FIG. 1, whereas the pure micron size particles give a final C—LiFePO₄ with microsize particles, and the pure submicronsize particles give final C—LiFePO₄ with submicron size particles, both with low packing density (with very low proportion of submicron size particles). It is also observe qualitatively that the bimodal material has a better space filling appearance and preservation of some large size pores which constitute electrolyte reservoir when the bimodal material is used in a liquid electrolyte cell.

The increase of packing density for the mixed submicron and micron sized particles is mainly because the fine particles can be filled in the interstitial holes formed by stacking the coarse particles. An optimized volume and size ratio of the fine to coarse particles can give improved packing density due to elimination of most large interstitial holes of the large particles. It is important to achieve this results, that the C coating deposit is kept low and preferably lower than 2.5% vs the phosphate, especially on the fine particles. FIG. 5 illustrates an optimised C coating layer of about 2-5 nm on fine submicronic particles obtained from iron chloride.

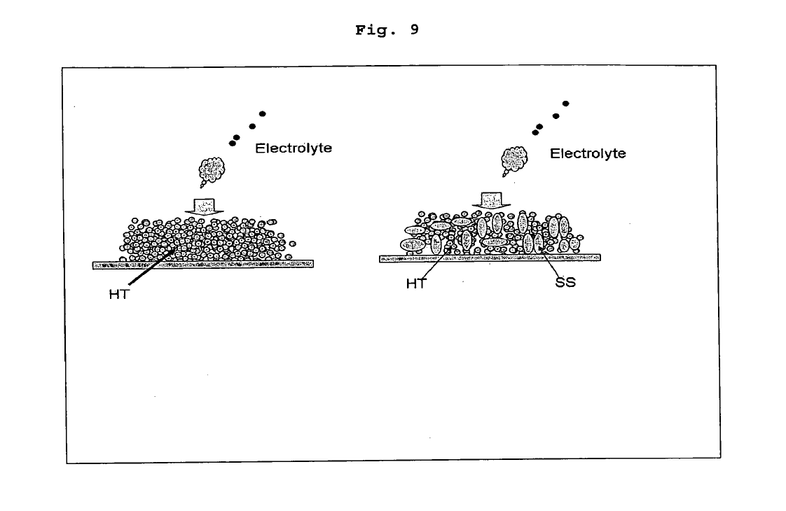

Example 1 has clearly demonstrated that the pore size and packing density can be engineered to approach optimized values by using a combination of fine and coarse particles with various particle size and size distribution for lithium iron phosphate materials despite the presence of a conductive C deposit required for electrochemical performance. Furthermore, very large pores with unnecessary pore volume can be controlled by filling, in certain ratio ranges, fine particles in the interstitial holes of large particles. On the other hand, when only submicron sized particles are packed together, the pore size and pore channels are small. Adding micron sized particles to submicron sized particles can create some large pores and large pore channels. A schematic drawing illustrates this point in FIG. 9.

Homogeneous particle mixing is critical to achieving high packing density and quality consistency. If the fine and coarse particles are segregated, the performance of the final product can not be improved. Since the submicron sized particles tend to rapidly form strong agglomerates or aggregates, it is very difficult to mix submicron sized particles with micron sized particles by conventional dry mixing methods.

Mixing LiMPO₄ particles or LiMPO₄ precursor particles (Li and metal sources) in a liquid medium is a preferred solution for mixing submicron or micron sized particles if the viscosity can be controlled to avoid separation of the coarse and fine particles. Experiments have been made to mix micron sized and submicron sized particles in IPA by ball milling using ceramic beads. It was found that both types of particles are evenly distributed when the viscosity is controlled in certain range. When the viscosity is too low, separation of the fine and coarse particles occurs. However, if the viscosity is too high, the fine particles cannot be dispersed and remain agglomerated together and upon sintering, the aggregates of fine particles are sintered together. It is not difficult to anticipate that high shear mixing can be very effective to mixing fine and coarse particles at optimized viscosity.

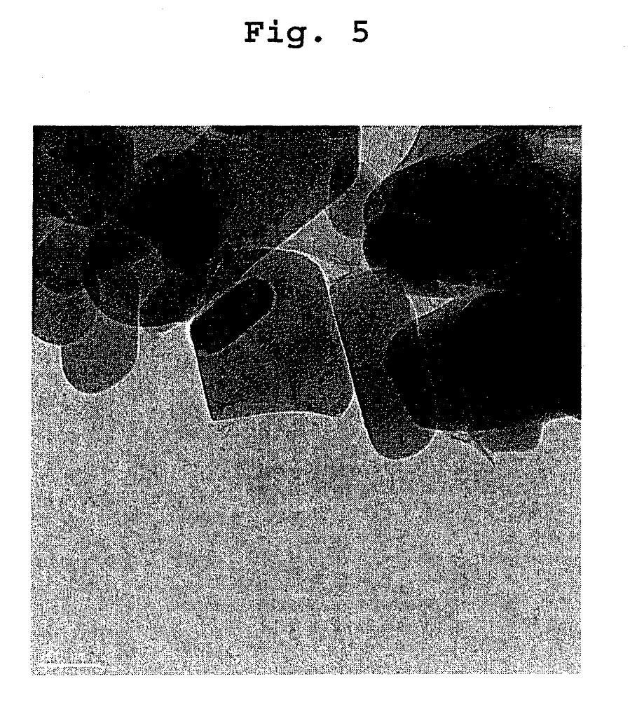

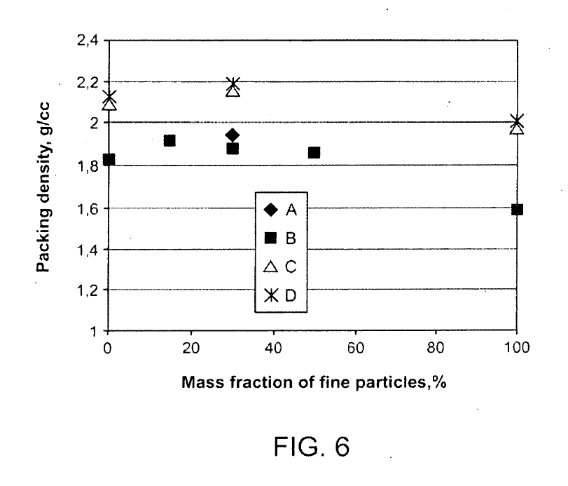

Alternatively dry mixing of fine particles can also be used. In such a case, the commonly used methods like magnetically assisted impaction mixing, hybridization system, mechanofusion and micro superfine mill are effective for mixing and/or coating the submicron sized particles on the micron sized particles. In some cases, a combination of various mixing steps can improve the homogeneity of the mix or the mixing can include other components, especially particulate carbon. This general trend on packing density is illustrated in FIG. 6 for mixtures made with components of different origin or treatment. Materials with various mixtures of micron sized particles and submicron sized particles have been tested.

| | |
|---|---|
| A | Material obtained from uncoated jet milled molten coarse particles |
| | and uncoated hydrothermal fine particles, mixed by ultrasonic in |
| | IPA solution, partially dried to obtain a paste which is then hand |
| | mixed for 10 minutes o using morter and pistel |
| B | Material obtained by the same method as material A, without hand |
| | mixing |
| C | Material obtained from carbon-coated micron sized LiFePO₄ |
| | synthesized from Budenheim iron phosphate coarse particles and |
| | carbon-coated hydrothermal LiFePO₄, mixed by ultrasonic |
| | dispersing in IPA solution |
| D | Material obtained by the same method as material C, with an |
| | additional hand mixing step |

Systematic study by the inventors has shown that fine particles are sintered more quickly than the coarse particles when the iron phosphate precursor particles are not well coated with polymer (acting as the carbon precursor) or when the sintering temperature is at 750° C. or above. To achieve desirable particle size ratio or volume (or mass) ratio of the fine particles to the coarse particles, it is critical to avoid the sintering as much as possible.

The rate performance of the three samples of Example 1 was compared at the same electrode thickness. FIG. 2 shows the Ragone plot of the three samples. As it can be seen, the fine particle C—LiFePO₄ material obtained from the Sud-Chimie precursor gives the highest power performance at low or medium C-rate up to 20 C (3 minutes). The coarse particle C—LiFePO₄ material synthesized from the Budenheim precursors gives the lowest power performance at all C rate up to 40 C (90 secondes). The bimodal material obtained from the mixed precursors gives a rate performance in the middle of the other two at low and medium C-rate up to 20° C. and then it outperforms the two others at higher C-rate above 20° C. This result could not be anticipated.

Clearly, it is advantageous to use a combination of fine particles and coarse particles to improve the power and energy density for very high power applications. Comparing with the fine particle products, the higher rate performance at very high C-rate is due to improvements of the lithium ions transport in the electrolyte as a result of large pores and lower tortuosity of the pore channels. Furthermore and not limitatively, it is possible that some surface effect additionally improves the Li-ion conductivity at the particle/electrolyte interface when particle packing is high (possible associated with a better percolation) and large surfaces are at play.

It is also expected that a combination of submicron sized particles and micron sized particles can also help to avoid overpressing in the calendaring process in order to achieve better packing density when making the composite electrode on its current collector. It will consequently avoid anisotropic alignment of active materials and non-uniform distribution of pores or avoid mechanical damage to the electrode foil or delamination to the collector.

The slow lithium ion transport in the solid particle determines that the size of the micron sized particles has to be in the lower micron range, in order to achieve reasonable power performance and material utilization at very high discharge rate. Systematic study by the inventors on C—LiMPO₄ revealed that the median particle size has to be below 5 microns, preferably below 2 microns in order to enable the cathode to deliver more power at 30 C to 40 C discharge rate.

This requirement for micron size particles consequently limited the size of the fine particles to lower submicron size in order to fill the fine particles in the interstitial holes of the large micron sized particles in anticipating high packing density. Preferably the median particle size of the submicron and micron particles should be in an optimum range of 0.05-0.15 and the volume fraction of the fine to coarse particles should be in the range of 20-40%.

Without limiting to the present examples, the particle size ratio and volume fractions of the mixture can be further optimized through using other sources of precursors or additional components. It is also expected that multimodal distribution can be achieved with improved energy density and power performance.

The use of a combination of various particle size iron precursors according to the present invention can also be beneficial to solving other problems associated with the synthesis of C—LiFePO₄. For instance, when using another source of ferric phosphate precursor synthesized by using a iron nitrate reactant for the synthesis of C—LiFePO₄, the carbon yield is found very low and not sufficient carbon deposition on the particle surface can be achieved for reasons still unknown. In such a case, a mixture of Budenheim and the other ferric phosphate precursors can generate desirable carbon yield during the organic precursor pyrolysis and give an effective carbon coating on the ex-ferric precursor particles despite this difficulty. Cost consideration of the product obtained from different synthesis ways is another factor in favour of particle mixing for equivalent or better electrochemical performances.

Mixing Iron Precursor Particles with LiMPO₄ Particles and Carbon-Coating the Mixture.

This mixing concept has been extended to a combination of solid state reaction particles made from an iron precursor with LiFePO₄ particles made by precipitation-hydrothermal synthesis.

Fine particle LiFePO₄ was synthesized by a precipitation-hydrothermal reaction. A mixture of this carbon free LiFePO₄ product, Budenheim coarse particles and lithium carbonate (said mixture having the nominal LiFePO₄ composition) was wet mixed with a solution of U550 polymer in IPA, then dried at ambient temperature and cooked at 710° C. under N₂ flow. C-coated LiFePO₄ was obtained by reaction of iron phosphate with lithium carbonate, and carbon coating of the hydrothermal bare LiFePO₄ occurred by polymer pyrolysis. The C % on the resulting bimodal material is 1.14 wt %.

Here again, as shown in Table 2, the packing density of the bimodal material is higher than that of a material consisting of fine particles or of coarse particles.

TABLE 2

| | Packing density |
|---|---|
| Material | g/cc |
| Budenheim precursor | 2.08 |
| Hydrothermal | 2.00 |
| 30% hydrothermal-70% (Budenheim iron phosphate/ | 2.20 |
| lithium carbonate) | |

According to the method of the present invention, a lithium iron phosphate material having high energy density is prepared by wet mixing micron sized lithium iron phosphate precursors with sub-micron (nano sized) lithium iron phosphate, and then reacting the mixture simultaneously with an organic carbon precursor in order to achieve C-coating by pyrolysis of said organic precursor in a controlled manner.

In order to achieve high performance utilization of the active material at medium or high rate (5 C-40 C), the iron precursor or the synthesis condition are selected so that the D100 value of the micron sized particles of the final C/LiFePO₄ product is preferably less than 15 micron. In a more preferred mode, the D100 is less than 8 microns. In some cases the synthesis of the LiFePO₄ might include grinding steps in order to fix the particles size and morphology in the micron or sub-micron range to achieve desired particle size and particle morphology. It is the case for example when the synthesis is made by melting reactants according to WO 2005/062404 A1.

In such a melt casting process, an ingot can be obtained. The ingot can be crashed into coarse particles by using a Jaw crasher or other mechanical means. After that, the coarse particles can be further milled by ball milling or jet milling to achieve various particle size distribution.

Experiments have also shown that certain combinations of fine particles and coarse particles prepared by a melt casting process of LiFePO₄ can improve the packing density. As is shown in Table 3, mixing of the fine particles and coarse particles gives a packing density higher than that of coarse particles alone. Optimized combination of the size ratio and volume fraction can further improve the packing density.

TABLE 3

| Material | Packing density g/cc |
|---|---|
| Jet milled molten coarse particles | 2.21 |
| Jet milled molten fine and coarse particles | 2.26 |

Systematic measurements show that a combination of the micron size particles and submicron sized particles before and after a thin layer carbon deposition on particle surface gives a packing density higher than that of micron size particles or submicron particles alone. This result is obtained whether the particles are produced by solid state reaction, by hydrothermal synthesis or by melt casting followed by milling.

In another aspect of the invention, the use of a combination of two different LiMPO₄ materials, i.e. a micron sized material and a submicron sized materiel, provides benefit from different kinetics, densities or different discharge plateaux.

In a bimodal material according to the invention, the D50 of the micron sized particles is preferably chosen in the range of 1-5 microns, while the standard deviation of the particle size distribution is preferably between 1.5-2 measured by a laser diffraction method.

The sub-micron or nano sized iron phosphate or lithium iron phosphate particles can be made by any method in the art including but not limited to hydrothermal reaction, polyol process, solid state reaction, molten synthesis including grinding to sub-micron size and wet chemistry precipitation methods. In a preferred embodiment, the D100 of fine particles is controlled below 2 micron. In another preferred embodiment, the D100 is below 0.5 microns. The D50 of the sub-micron sized particles is preferably chosen between 0.1-0.5 microns. When the particle size is in the low submicron range, laser diffraction method to measure particle is not reliable any more, particle size determination has to be performed with SEM/TEM observation and light scattering methods.

The ratio of the D50 of the submicron sized particles to the D50 of micron sized particles is preferably between 0.02-0.5. More preferably, said size ratio is 0.08-0.15.

The volume or weight ratio of the sub-micron size particles to the micron sized particles is chosen according to the need of energy density and rate performance. In a preferred mode to achieve high energy density at medium or low rate performance, a combination of various size distributions can be used to obtain bi-modal, three-modal or even multi-modal distribution. In the case of three-modal size distribution, the medium sized particles are intended to fill the interstitial holes created by large particles, while the fine particles are intended to fill interstitial holes of medium sized particles.

Preferably, the volume ratio of the submicron sized particles to micron sized particles is chosen between 20-50%. More preferably, said volume ratio is chosen between 25-35%.

Mixing Already Synthesised LiMPO₄ Particles Before or After Carbon Coating.

It is not difficult to understand that the desirable combination of C—LiFePO₄ can be made by mixing the final products from various synthesis processes. In this case, coarse C—LiFePO₄ can be made by solid state reaction using various iron, lithium or phosphate compound precursors in the presence of a C precursor. Mixing already synthesized C-coated particles allows to control and fix independently different C conductive additive (nature and %) on the coarse particles as well as on the fine particles for better energy optimisation. The mixing of fine particles and coarse particles can be done by low energy ball milling in a conventional ball mill using ceramic beads or by high shearing mixing in NMP solution. The mixing of fine particles and coarse particles can further be made by first premixing in a dry process (like mechanofusion) and then using the mixed powder as such as active material for cathode preparation by usual cathode composite compounding and coating.

In one embodiment, LiFePO₄ can be made by melt casting followed by a milling process. First, LiFePO₄ is made by melting an iron precursor, a lithium precursor, and a phosphate precursor in an inert or reducing environment to make liquid LiFePO₄, and then casting the liquid in moulds under inert or reducing atmosphere to obtain a solidified ingot of LiFePO₄. The ingot can be crashed into millimetre sized coarse particles by using a jaw crasher. In a final step, the millimetre sized coarse particles can be brought down to micron size by ball milling or jet milling, or to sub-micron particle sizes.

The fine particles can be made by solid state reaction using fine precursors or by wet chemistry methods like co-precipitation and sol-gel processes. These processes have been widely investigated to make homogeneous sintering precursors at atomic scale and in principle, a low pyrolysis temperature is needed to achieve fine particle size of final products.

Hydrothermal reaction is one of the most elegant methods to synthesize lithium metal phosphate. Lithium iron phosphate particles with various well controlled particle sizes and morphologies can be made under moderate hydrothermal conditions. Depending on the precursors and hydrothermal conditions, various particle sizes and shapes have been obtained such as submicron size ellipsoids, micron size hexagonal plate and heavily agglomerated nanospheres or nano-rods.

Clearly, each specific processing route gives a typical particle structure, particle size, size distribution and particular morphology. Therefore, each product has its advantages and disadvantages when being used as a cathode material to achieve high utilization for various power rate requirements. For instance, the micron sized large particles (elementary or secondary) made by the solid state method limits the high power performance by slow lithium ion transport in the solid phase, but can improve the volumetric density of the electrode and lithium ion transport in the electrolyte by forming large pores and reduce the tortuosity of lithium ion path then increasing its transport in the electrolyte. On the contrary, the sub-micron sized small particles made by hydrothermal reactions are beneficial for reducing the diffusion length of lithium ions in the solid state, but limit lithium ion transport in the electrolyte at very high power drain due to the small pore size and high tortuosity of pore channels, and they make the composite cathode compounding and optimization more difficult due to large surfaces involved.

In another non limitative interpretation, the coarse particles have a limited diffusion rate to the core of the particles contrary to the fine particles. Therefore, the mixing of coarse and fine particles allows to make an optimal product. During discharge/charge of a mixture of coarse and fine particles at high rate, the lithium-ions insert/de-insert first into fine particles and then in coarse particles, thus reducing the stress in the C—LiFePO₄ particles at high rates from such a transient buffer effect. Such a mixing effect is beneficial especially when the fine particles are reduced to submicron and nano dimensions (<100 nm) by the end of discharge/charge.

### Example 1

A bimodal LiFePO₄ material comprising fine particles and coarse particles was synthesized by a solid state sintering process as described in WO0227823 and U.S. Pat. No. 7,285,260.

In summary, a first FePO₄.2H₂O precursor received from Bundenheim was jet milled to obtain micron sized particles with D50 of 2.3 microns.

70 wt. % of this jet milled Budenheim iron phosphate was mixed with 30 wt. % of a submicron sized iron phosphate (ALEP) made by controlled precipitation of an iron chloride precursor and phosphoric acid. To this mixture were added an adequate amount of lithium carbonate sold by Limtech and Unithox® polymer (as the carbon precursor) dissolved in IPA. The resulting mixture was homogeneized by ball milling using ceramic beads for 24 hours. The slurry was dried by using dry air.

Sintering synthesis is performed in a rotary kiln using a stainless steel reactor under the protection of a N₂ flow. The powder was heated to 710° C. at a heating rate of 6° C./min and held for lh at this temperature to complete the reaction. It was then cooled down in the furnace. LECO measurement gives a carbon content of 1.42 wt %. FIG. 1 shows the SEM images of each C—LiFePO₄ constituent and their mixture.

The packing density of the powders was measured in a die with a punch by applying uniaxial pressure up to (47 MPa). In order to achieve the same conditions, each measurement uses the same amount of powder and pressure. As shown in Table 1, higher packing density is observed on the bimodal material vs the pure components in comparative conditions.

Liquid electrolyte battery preparation was made according the following procedures: C—LiFePO₄, as prepared in example 1, a PVdF-HFP copolymer (from Atochem) and EBN1010 graphite powder (from Superior Graphite) were thoroughly mixed in N-methyl pyrolidone (NMP) with zirconia balls for 1 hour on a turbula shacker, in order to obtain a 80/10/10 wt % proportion of the components. This slurry was then coated on a carbon-coated aluminum foil (from Intellicoat) with a Gardner coater, the film was dried under vacuum at 80° C. during 24 hours prior to storage in a glove box. A button type battery has been assembled and sealed in a glove box using cathode coating, a 25 μm microporous separator (from Celgard) impregnated with 1M/1 LiPF₆ salt in EC:DEC electrolyte and a lithium foil as the anode. Electrochemical performance of the mixture according to example 1 is represented on FIG. 2 in comparison with comparative example 1 and 2, showing superior behavior of the bimodal material as compared to the pure coarse material and the pure fine material.

### Comparative Example 1

A battery was assembled according to the method of Example 1, the only difference being that only the Budenheim iron phosphate precursor is used in the synthesis of the cathode material.

### Comparative Example 2

A battery was assembled according to the method of Example 1, the only difference being that only the ALEP iron phosphate precursor is used in the synthesis of the cathode material.

### Example 2

FePO₄.2H₂O from Bundenheim was jet milled to obtain micron sized particles with D50 of 2.3 microns.

70 wt. % of mixture comprising the jet milled Budenheim iron phosphate precursor and lithium carbonate and 30% of LiFePO₄ made by a precipitation-hydrothermal process was mixed with 5% Unithox® polymer in IPA solution using a ball mill and ceramic beads. The obtained slurry was dried using dry air.

The sintering synthesis was performed on a rotary kiln as described in example 1. The packing density was measured using the sample method as described in example 1. Results in Table 2 show a packing density for the mixture higher than that for the pure components.

### Example 3

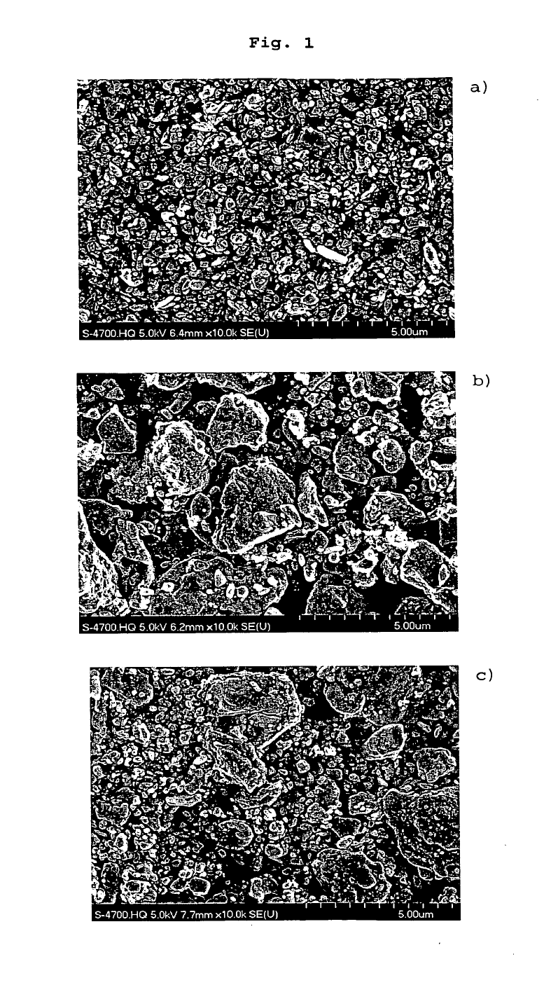

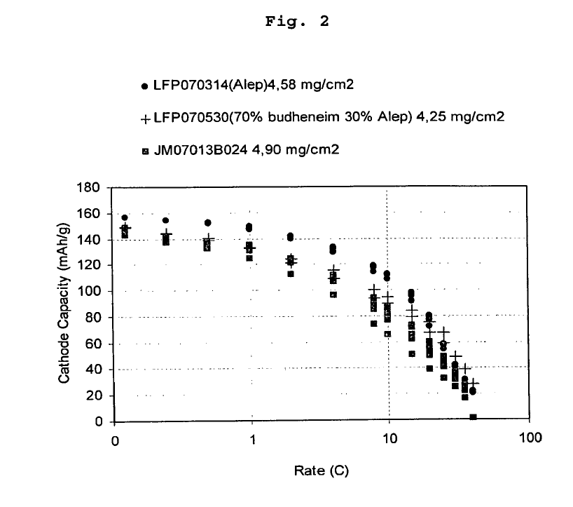

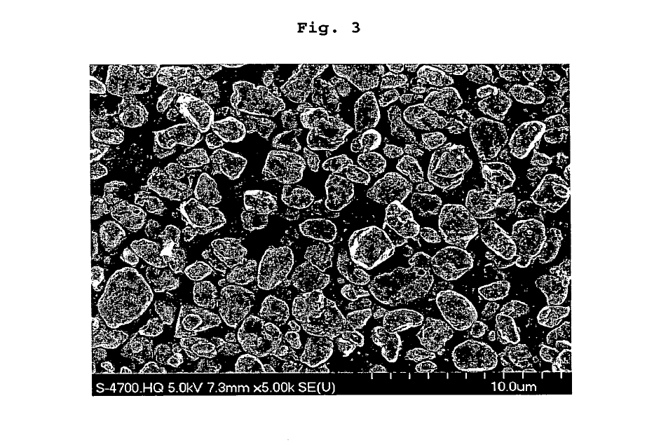

LiFePO₄ made by a molten process is ground from the ingot to mm size particles by jaw crusher and roller. Part of these mm size particles are fed in a Jet mill and ground to micron size particles, and part of the mm size particles are ground to submicron size particles. These two particle products are mixed together mechanically to optimize packing density. Results are shown in Table 3 and FIG. 3. Similar results are found when micron size particles and submicrosize particles are prepared from molten LiMnPO₄ and mixed together.

### Example 4

Two C-coated LiFePO₄ from two different synthesis routes are mixed.

A coarse micron size C—LiFePO₄ (identified as P1) is made by a solid state reaction (P1-SS) using a Budenheim iron phosphate precursor and lithium carbonate in the presence of Unithox® as a carbon precursor, as described in Example 1. Conductive carbon deposit represents 1.4 wt % vs LiFePO₄. The obtained C—LiFePO₄ was jet milled to particles with D50 of 2.3 microns.

Submicron sized C—LiFePO₄ (identified as P2) was obtained through a precipitation-hydrothermal reaction according to WO 2005/051840A1. The obtained carbon-free submicron-sized particles particles are mixed with Lactose in water solution and then spray dried. The obtained Lactose coated LiFePO₄ was further carbonized in a rotary kiln as described in example 1. The C—LiFePO₄ was finally jet milled to de-agglomerate the secondary particles. Two P2 carbon ratio samples have been made for evaluation, one P2-HT1 with C to LiFePO₄ wt ratio of 1.8%, the other, P2-HT2 whose ratio is 2.1%.

Electrodes are prepared first by mixing together in various proportions with energetic mechanical means (such as a 30 minutes mechanofusion), the two C—LiFePO₄ powders (micron sized and submicron sized particles) with 3% carbon black and 3% VGCF C fibers. Each solid mixture is then introduced in a PVDF (PolyVinylidene DiFluoride) 12% wt solution in NMP (N-Methyl Pyrollidone) and intimately mixed over 60 minutes in a steel ball mill and the suspension coated on a 15 micron thick Al foil collector. In order to allow comparison, coating is made using a coating slot with a constant opening fixed at 5 mils.

Dried electrodes are then calendered and thickness is measured before and after calendering in order to calculate the electrode density for the as-coated film and for the film after calendering. Table 4 confirms that the density of the electrode with different compositions is of the same order after calendering, about 2 g/cc with a mean thickness of 35 microns. This is important to allow comparison of cell performances with different compositions of comparable thickness and density.

TABLE 4
Summary of the electrode densities as function of the cathode composition.

| | | | Thikcness (μm) | Density (g/cc) | Thickness (μm) | Density (g/cc) |
|---|---|---|---|---|---|---|
| Cathode | | Electrode | Before | Before | After | After |
| film # | Cathode composition | Weight/mg | calendering | calendering | calendring | calendering |
| LPK210 | 100% P1-SS | 16.5 | 39 | 1.69 | 32 | 2.38 |
| LPK211 | 100% P2-HT1 | 16.7 | 41 | 1.60 | 34 | 2.18 |
| LPK212 | 100% P2-HT2 | 18.3 | 46 | 1.60 | 39 | 2.06 |
| LPK213 | 20% P1-SS + 80% P2-HT1 | 18.2 | 44 | 1.69 | 37 | 2.23 |
| LPK215 | 50% P1-SS + 50% P2-HT1 | 17.4 | 43 | 1.61 | 36 | 2.14 |
| LPK216 | 50% P2-HT1 + 50% P2-HT2 | 17.2 | 42 | 1.63 | 36 | 2.10 |
| LPK217 | 20% P1-SS + 80% P2-HT2 | 18.2 | 45 | 1.63 | 38 | 2.13 |
| LPK218 | 33% P1-SS + 33% P2-HT1 + 33% P2-HT2 | 16.5 | 39 | 1.69 | 34 | 2.13 |
| | Mean Value | 17.38 | 42.38 | 1.64 | 35.75 | 2.17 |

Different electrochemical cells are made with the films of each composition as indicated in Table 4. The anode is a lithium metal foil, the electrolyte is a 1M LiPF₆ in a EC+DEC solvent with a Celgard® 35001 and the cathode the different C—LiFePO₄ composite on an Al collector. Electrode area is 12 cm². Soft metal-plastic material is used for the electrochemical tests packaging.

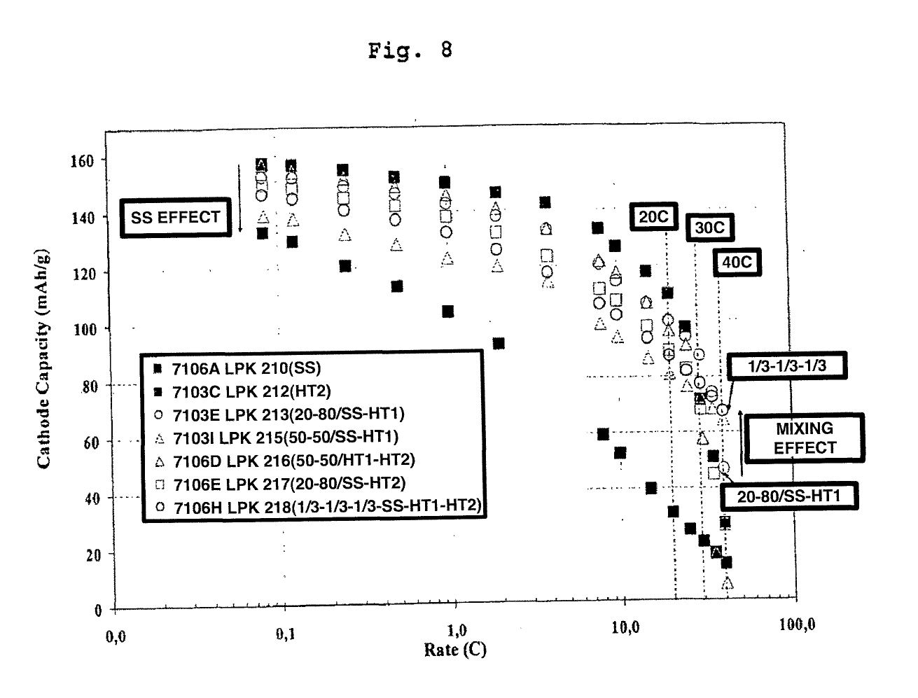

Comparative electrochemical performance is presented in FIG. 8 where capacity (mAh/g) is shown as function of the discharge rate (C). The discharge rate varies between C/12 (12 hours) and 40 C (90 seconds) while the charge rate is held constant at C/4 (4 hours). Voltage limits are 4 and 2 Volts. At low current, the 100% P2-HT2 electrode composition shows the highest capacity at 160 mAh/g contrary to the 100% P1-SS which shows only 133 mAh/g. At high current, the 100% P2-HT2 maintained better performance compared to 100% P1-SS. However, when cathode bimodal materials are used, both 20:80 wt % (P1-SS:P2-HT1) and 20:80 wt % (P1-SS-P2-HT2) mixtures have better performances as compared to pure P1-SS or P2-HT2. It is also interesting to note that at high rate (40 C) the delivered capacity by the bimodal material is better when the C % on the sub micron particle is less (20:80% P1-SS:P2-HT1) that the equivalent mixture in which the C % is higher (20:80% P1-SS:P2-HT2) thus showing the importance of optimizing the C deposit on the sub micron particles independently in this case of the carbon deposit on the coarse particles.

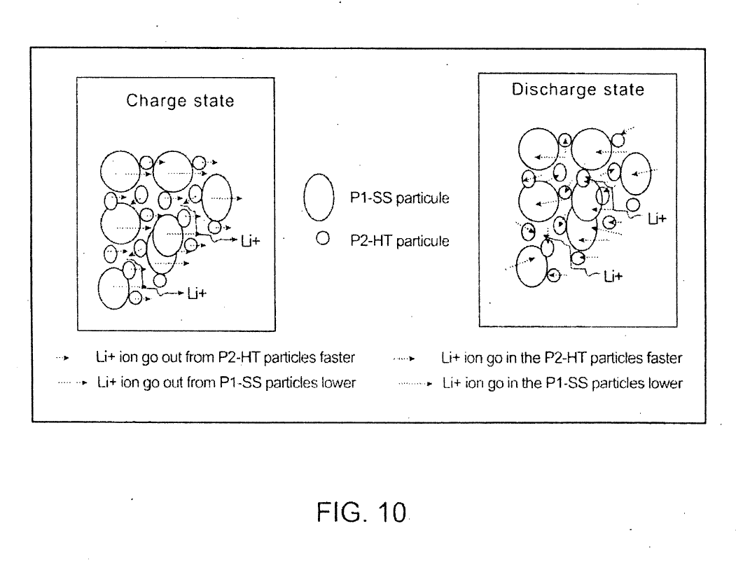

At 40 C rate, the best performance is with the (33 wt % P1-SS+33 wt % P2-HT1+33 wt % P2-HT2) with a capacity of 69 mAh/g. This unexpected result can be tentatively explained on FIG. 8 which shows that coarse particles (and particle shape) can increase packing density but also create porosity in the composite electrode and allow electrolyte penetration and particle wetting while allowing more or less the filling of the porosity with sub micron particles depending on the volumetric ratio of each constituent of the mixture. Another possible effect might involve some kinetic buffer effect of the small particles vs large particles on discharge and charge as illustrated schematically in FIG. 10. However these speculative explanations are in no way a limitation of the invention that is based on physical and electrochemical effects observed in the examples.

From these examples, the bimodal material cathode can be optimized, depending on the addressed application for energy and compaction but also for power especially at high rates where the mixture of micron sized and submicron sized (nano scale) reveals a higher power performance than the pure constituents of the mixture in comparable conditions.

1. A cathode material comprising particles, said particles having a lithium metal phosphate core and a pyrolytic carbon deposit, wherein said particles have a synthetic multimodal particle size distribution comprising at least one fraction of micron size particles and at least one fraction of submicron size particles, said lithium metal phosphate having formula LiMPO₄ wherein M is at least Fe or Mn.

2. A cathode material of claim 1, wherein M represents Fe^{II} or Mn^{II} optionally partly replaced with not more than 50 atomic % of at least one metal selected from the group consisting of Mn, Fe, Ni and Co, and optionally replaced with not more than 10 atomic % of at least one aliovalent or isovalent metal different from Fe, Mn, Ni or Co.

3. A cathode material of claim 2, wherein the aliovalent or isovalent metal is selected from the group consisting of Mg, Mo, Nb, Ti, Al, Ta, Ge, La, Y, Yb, Sm, Ce, Hf, Cr, Zr, Bi, Zn, Ca and W.

4. A cathode material of claim 1, wherein the core of all the particles is made of a lithium metal phosphate having the same chemical formula LiMPO₄.

5. A cathode material of claim 1, wherein the lithium metal phosphate of said fraction of micron size particles having one size distribution is different from the lithium metal phosphate of said fraction of submicron size particles having a different size distribution.

6. A cathode material of claim 1, wherein the LiMPO₄ is LiFePO₄ or LiMnPO₄.

7. A cathode material of claim 1, wherein the micron sized particles have a D50 in the range of 1-5 μm and a D97 of less that 10 μm.

8. A cathode material of claim 1, wherein the submicron sized particles have a D50 of 0.1-0.5 μm and a D97 of less than 10 μm, preferably less than 4 μm.

9. A cathode material of claim 1, wherein the median size ratio of the submicron to micron sized particles is in the range of 0.02-0.5, preferably in the range of 0.08-0.15.

10. A cathode material of claim 1, wherein the micron size particles and submicron size particles are made of primary particles each consisting of a single phosphate crystallite, or of secondary particles each consisting of a plurality of phosphate crystallites and behaving as a single crystallite when submitted to a mechanical mixing step.

11. A cathode material of claim 1, wherein the particle size distribution is bimodal and comprises micron size particles and submicron size particles.

12. A cathode material of claim 1, wherein the particle size distribution is trimodal and the material comprises 3 fractions of particles, wherein at least one fraction consists of submicron size particles, and at least one fraction consists of micron size particles.

13. A cathode material of claim 1, wherein the volume fraction of the submicron particles is in the range of 20-50%, preferably in the range of 25-35%.

14. A cathode material of claim 1, wherein the carbon deposit in the submicron sized particles is a carbon layer of partially graphitized carbon attached to the particle surface and has a thickness of 1 to 15 nm.

15. A cathode material of claim 1, wherein the pyrolytic carbon deposit on submicron particles represents a ratio of 0.5 to 10% wt in the mixture and preferentially between 0.5 to 2.5% wt.

16. A cathode material of claim 1, which further comprises additional carbon in the form of carbon black, graphite, or fibers, between the particles which are agglomerated or not agglomerated.

17. A method for preparing a cathode material according to claim 1, said method comprising the steps of:
providing starting micron sized particles of at least one lithium metal phosphate or of precursors of a lithium metal phosphate;
providing starting submicron sized particles of at least one lithium metal phosphate or of precursors of a lithium metal phosphate;
mixing by mechanical means said starting micron sized particles and said starting submicron size particles;
making a pyrolytic carbon deposit on the lithium metal phosphate starting particles before or after the mixing step, or on their metal precursor before or after mixing the particles;
optionally adding carbon black, graphite powder or fibers to the said lithium metal phosphate particles before the mechanical mixing.

18. The method of claim 17, wherein the median size ratio of the starting submicron size particles to the starting micron sized particles is in the range of 0.02-0.5 and the volume fraction of the starting submicron size particles in the range of 20-50%.

19. The method of claim 17, wherein the starting submicron sized particles have a D50 of 0.1-0.5 μm and a D97 of less 10 μm, preferably less than 4 μm.

20. The method of claim 17, wherein the starting micron sized particles have a D50 in the range of 1-5 μm and a D97 of less that 10 μm.

21. The method of claim 17, wherein the starting micron size particles and the starting submicron size particles are LiMPO₄ particles.

22. The method of claim 17, wherein the synthesis route of the starting micron size particles is different from the synthesis route of the starting submicron size particles.

23. The method of claim 17, wherein the starting micron size particles and the starting submicron size particles are LiMPO₄ precursors particles.

24. The method of claim 17, wherein the starting micron size particles are LiMPO₄ particles and the starting submicron size particles are LiMPO₄ precursors particles, or the starting micron size particles are LiMPO₄ precursor particles and the starting submicron size particles are LiMPO₄ particles.

25. The method of claim 17, wherein the lithium metal phosphate or the precursors of a lithium metal phosphate of the starting micron sized particles are different from the lithium metal phosphate or the precursors of a lithium metal phosphate of the starting submicron sized particles.

26. The method of claim 17, wherein the mixing step by mechanical means is a dry mixing or a mixing in a liquid medium.

27. The method of claim 17, wherein the mechanical mixing means are selected from the group consisting of high shear mixing, wet milling, cogrinding, magnetically assisted impaction mixing, hydrydization system, mechanofusion, and micro superfine mill.

28. The method of claim 17, wherein the starting particles are prepared by a precipitation-hydrothermal synthesis reaction, and optionally brought to micron size or submicron size by grinding or milling.

29. The method of claim 17, wherein the starting particles are synthesized by solid state sintering, and optionally brought to micron size or submicron size by grinding or milling.

30. The method of claim 17, wherein the starting particles are prepared by a molten process and brought to micron size or submicron size by grinding or milling.

31. The method of claim 17, wherein the starting submicron size particles are prepared by a sol-gel or by spray pyrolysis methods of synthesis.

32. The method of claim 17, wherein the starting micron size particles are prepared by jet milling of larger particles.

33. The method of claim 28, wherein the particles obtained by the precipitation-hydrothermal synthesis reaction are mixed with a carbon precursor and pyrolyzed, for the preparation of particles with a carbon deposit.

34. The method of claim 29, wherein the solid state sintering is performed in the presence of a carbon precursor, for the preparation of particles with a carbon deposit.

35. The method of claim 30, wherein the molten process is performed in the presence of a carbon precursor, for the preparation of particles with a carbon deposit.

36. The method of claim 17, wherein the starting micron size particles and the starting submicron size particles are LiMPO₄ particles having a carbon deposit.

37. The method of claim 17, wherein the starting micron size particles and/or the starting submicron size particles are LiMPO₄ precursors particles, the mixture subjected to mixing comprises a carbon precursor, and pyrolysis is performed after mixing.

38. The method of claim 17, wherein the starting micron size particles and/or the starting submicron size particles are LiMPO₄ particles having no carbon deposit, the mixture subjected to mixing comprises a carbon precursor, and pyrolysis is performed after mixing.
